(19) United States
(12) Patent Application Publication
(10) Pub. No.: US 2026/0368447 A1
(43) Pub. Date: Nov. 19, 2026

(54) INFORMATION PROCESSING DEVICE AND INFORMATION PROCESSING METHOD

(71) Applicant: Semiconductor Energy Laboratory Co., Ltd., Atsugi-shi (JP)

(72) Inventors: Kengo AKIMOTO, Isehara (JP); Junpei MOMO, Sagamihara (JP)

(21) Appl. No.: 19/661,847

(22) Filed: Apr. 29, 2026

(30) Foreign Application Priority Data
May 16, 2025 (JP) 2025-082327

(51) Int. Cl. G06F 40/40; G06F 40/20; G06Q 50/18

(52) U.S. Cl. CPC G06F 40/40; G06F 40/20; G06Q 50/184

(57) ABSTRACT

To provide an information processing device enabling creation of a highly complete document related to an intellectual property. A first document showing a first component and a second document related to the first document, and references are obtained. A plurality of components that can be combined with the first component and are not described in any of the references are extracted from the second document using a language model, so that second components are obtained. A third component selected by a user from the second components and a technical idea related to the third component, which is input by the user, are obtained. A component describing an obstructive factor of combination with the first component is selected from the third component using the language model, so that a fourth component is obtained. The obstructive factor is described in any of the references. On the basis of a fifth component that is a combination of the first component and the fourth component, the technical idea, and the obstructive factor, a third document is generated by the language model. The number of characters included in the second document can be larger than the number of characters included in the first document.

### BACKGROUND OF THE INVENTION

### 1. Field of the Invention

One embodiment of the present invention relates to an information processing device. Another embodiment of the present invention relates to an information processing method using an information processing device. Another embodiment of the present invention relates to an information processing system including an information processing device.

Note that one embodiment of the present invention is not limited to the above technical field. The technical field of one embodiment of the invention disclosed in this specification and the like relates to an object, a method, or a manufacturing method. Alternatively, one embodiment of the present invention relates to a process, a machine, manufacture, or a composition of matter. Thus, more specifically, examples of the technical field of one embodiment of the present invention disclosed in this specification include an information processing device, a semiconductor device, a memory device, a driving method thereof, and a manufacturing method thereof.

### 2. Description of the Related Art

A document relating to a patent application, e.g., a patent specification, needs to disclose an invention that satisfactorily meets the novelty and the inventive step. In other words, the patent specification, for example, needs to disclose a component that is not completely the same as components already known at the time of application and that does not easily allow a combination of a plurality of the known components. Patent Document 1 discloses a method for determining the patentability of claims with a machine learning model and generating a patent specification automatically when the patentability is at a predetermined level or higher.

In recent years, language models using artificial neural networks (ANNs, hereinafter also simply referred to as neural networks) have been actively developed, and large language models (LLMs) in particular have attracted attention. A large language model is a natural language processing model trained using a large amount of data. With a large language model, for example, an interactive model that gives an answer to a user's instruction can be achieved. In Non-Patent Document 1, Generative Pre-Trained Transformer 4 (GPT-4, registered trademark) is disclosed as a large language model, and ChatGPT is disclosed as an interactive model. Other examples of large language models include Language Model for Dialogue Applications (LaMDA), Pathways Language Model (PaLM), Llama2, and Llama3.

### Reference

[Patent Document 1] International Publication No. WO2020/240872

### Non-Patent Document

[Non-Patent Document 1] Summary of ChatGPT/GPT-4 Research and Perspective Towards the Future of Large Language Models, Yiheng Liu et al., (submitted on 4 Apr. 2023) [online], Internet URL: https://arxiv.org/abs/2304.01852

### SUMMARY OF THE INVENTION

However, in Patent Document 1, automatic generation of the patent specification is not carried out when the claims have lower patentability than a predetermined level.

In view of the above, an object of one embodiment of the present invention is to provide an information processing device, an information processing method, and an information processing system that present a component satisfactorily meeting the novelty and the inventive step and prepare a document such as a patent specification on the basis of the presented component. Another object of one embodiment of the present invention is to provide an information processing device, an information processing method, and an information processing system that assist in new creation. Another object of one embodiment of the present invention is to provide an information processing device, an information processing method, and an information processing system that can prepare a highly complete document related to an intellectual property. Another object of one embodiment of the present invention is to provide an information processing device, an information processing method, and an information processing system that can reduce the workload on a user in preparing a document related to an intellectual property. Another object of one embodiment of the present invention is to provide an information processing device, an information processing method, and an information processing system that can prepare a document related to an intellectual property in a short time.

Another object of one embodiment of the present invention is to provide an information processing device, an information processing method, and an information processing system that are highly convenient and useful. Another object of one embodiment of the present invention is to provide a novel information processing device, a novel information processing method, and a novel information processing system.

Note that the description of these objects does not preclude the existence of other objects. One embodiment of the present invention does not need to achieve all of these objects. Other objects will be apparent from and can be derived from the description of the specification, the drawings, the claims, and the like.

One embodiment of the present invention is an information processing method in which a first document describing a first component, at least one second document related to the first document, and at least one reference related to the first document are obtained, in which a first prompt for extracting a plurality of components that are capable of being combined with the first component and are not described in the reference from the second document is transmitted to a language model, so that a plurality of second components are obtained, in which a plurality of third components selected from the plurality of second components and technical ideas related to the respective plurality of third components are obtained, in which a second prompt for selecting a component that has a factor described in the reference and obstructing combination with the first component, from the plurality of third components is transmitted to the language model, so that at least one fourth component is obtained, in which a third prompt for generating a document based on a fifth component that is a combination of the first component and the fourth component, any of the technical ideas related to the fourth component, and the obstructive factor is transmitted to the language model, so that a third document is obtained, and in which the third document is presented.

Another embodiment of the present invention is an information processing method including a first, a second, a third, a fourth, a fifth, a sixth, a seventh, and an eighth steps: in the first step, a first document describing a first component and at least one second document related to the first document are received; in the second step, at least one reference related to the first document is obtained; in the third step, a first prompt for extracting a plurality of second components that are capable of being combined with the first component and are not described in the reference from the second document is created and transmitted to a language model; in the fourth step, the second components are presented; in the fifth step, a plurality of third components selected from the second components and technical ideas related to the respective plurality of third components are received; in the sixth step, a second prompt for selecting at least one fourth component that has a factor described in the reference and obstructing combination with the first component, from the plurality of third components, is created and transmitted to the language model; in the seventh step, a third prompt for generating a third document based on a fifth component that is a combination of the first component and the fourth component, any of the technical ideas related to the fourth component, and the obstructive factor is created and transmitted to the language model; and in the eighth step, the third document is presented.

Another embodiment of the present invention is an information processing device including a reception unit, an output unit, and a processing unit. In the information processing device, the reception unit is configured to receive a first document describing a first component, at least one second document related to the first document and describing a second component, a plurality of third components selected from the second component, and technical ideas related to the respective plurality of third components; the output unit is configured to transmit a first prompt, a second prompt, and a third prompt to a language model; the output unit is configured to output the second component and a third document; and the processing unit is configured to obtain at least one reference related to the first document, to create the first prompt for extracting a plurality of the second components that are capable of being combined with the first component and are not described in the reference, to present the extracted second components, to create the second prompt for selecting at least one fourth component that has a factor described in the reference and obstructing combination with the first component, from the plurality of third components, and to create the third prompt for generating the third document based on a fifth component that is a combination of the first component and the fourth component, any of the technical ideas related to the fourth component, and the obstructive factor.

In the above embodiment, the number of characters included in the second document may be larger than the number of characters included in the first document.

In the above embodiment, the reference may be stored in a database.

In the above embodiment, each of the first to third documents and the reference may be a technical document.

In the above embodiment, the third document may be a specification belonging to a patent application or a specification belonging to a utility model registration application.

In the above embodiment, the first document may be a document describing creation, and the second document may be a report of an experiment related to the creation.

One embodiment of the present invention can provide an information processing device, an information processing method, and an information processing system that present a component satisfactorily meeting the novelty and the inventive step and that prepare a document such as a patent specification based on the presented component. Another embodiment of the present invention can provide an information processing device, an information processing method, and an information processing system that assist in new creation. Another embodiment of the present invention can provide an information processing device, an information processing method, and an information processing system that can prepare a highly complete document related to an intellectual property. Another embodiment of the present invention can provide an information processing device, an information processing method, and an information processing system that can reduce the workload on a user in preparing a document related to an intellectual property. Another embodiment of the present invention can provide an information processing device, an information processing method, and an information processing system that can prepare a document related to an intellectual property in a short time.

Another embodiment of the present invention can provide an information processing device, an information processing method, and an information processing system that are highly convenient and useful. Another embodiment of the present invention can provide a novel information processing device, a novel information processing method, and a novel information processing system.

The description of these effects does not preclude the existence of other effects. One embodiment of the present invention does not necessarily have all of these effects. Other effects will be apparent from and can be derived from the description of the specification, the drawings, the claims, and the like.

### BRIEF DESCRIPTION OF THE DRAWINGS

FIG. 1 is a schematic view showing an example of an information processing system.

FIG. 2 is a block diagram showing an example of an information processing system.

FIG. 3 is a flow diagram showing an example of an information processing method.

FIG. 4 is a flow diagram showing an example of an information processing method.

FIG. 5 is a schematic diagram showing an example of a GUI.

FIG. 6 is a flow diagram showing an example of an information processing method.

FIG. 7 is a flow diagram showing an example of an information processing method.

FIGS. 8A and 8B are flow diagrams showing an example of an information processing method.

FIG. 9 is a schematic diagram illustrating an example of a GUI.

FIG. 10 is a flow diagram showing an example of an information processing method.

FIG. 11 is a flow diagram showing an example of an information processing method.

FIG. 12 is a flow diagram showing an example of an information processing method.

FIG. 13 is a flow diagram showing an example of an information processing method.

FIG. 14 is a schematic diagram illustrating an example of a GUI.

### DETAILED DESCRIPTION OF THE INVENTION

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Thus, the present invention should not be construed as being limited to the description in the following embodiments. Note that in structures of the invention described below, the same portions or portions having similar functions are denoted by the same reference numerals in different drawings, and the description thereof is not repeated.

Although a block diagram in which components are classified by their functions and shown as independent blocks is shown in the drawing attached to this specification, it is difficult to completely separate actual components according to their functions and one component can relate to a plurality of functions.

In this specification, the drawings, and the like, when a plurality of components are denoted by the same reference numeral, and, particularly when they need to be distinguished from each other, identification signs such as “_1”, “[n]” or “[m, n]” are sometimes added to the reference numeral, for example. When matters common to a plurality of components with identification signs are described or they do not need to be distinguished from each other, no identification sign is added in some cases.

In this specification and the like, the terms “first” and “second” are sometimes used for easy understanding of the technical contents or identification of components. Thus, the terms “first” and “second” do not limit the number of components. The terms “first” and “second” do not limit the order of components. In addition, the terms such as “first” and “second” or identification numerals used in this specification do not correspond to the terms or the identification numerals in the scope of claims of this application in some cases.

### Embodiment

This embodiment will describe an information processing system of one embodiment of the present invention. This embodiment will also describe an information processing device included in the information processing system and an information processing method using the information processing system.

One embodiment of the present invention relates to an information processing system that generates a third document based on first and second documents with use of a language model. The first to third documents can be technical documents.

The first document can be a document describing creation, e.g., a document describing an invention or a device. Specifically, the first document can be a document describing creation to be filed. The second document is a document related to the first document, e.g., a report of an experiment relating to the creation described in the first document. The third document can be an application document related to an intellectual property, e.g., a specification belonging to a patent application or a specification belonging to a utility model registration application. Here, a specification belonging to a patent application and a specification belonging to a utility model registration application are collectively and simply referred to as a specification.

An invention and a device are each creation of a technical idea utilizing the natural law. Thus, the term “creation” refers to both the invention and the device. Here, the invention is protected by a Patent Act. The device is protected by a Utility Model Act.

In this specification and the like, a patent application includes an international patent application. A utility model registration application includes an international utility model registration application. An international patent application refers to an international application that has entered the national (or regional) phase as a patent application. An international utility model registration application refers to an international application that has entered the national (or regional) phase as a utility model registration application. Here, an international application refers to, for example, an application based on the Patent Cooperation Treaty (PCT).

By an information processing method of one embodiment of the present invention, a third document describing creation that is a combination of a component described in the first document with part of a component described in the second document is generated. A language model is used to extract the component described in the second document. Thus, even when the volume of the second document is extremely large, a component that can be combined with the component described in the first document can be extracted from the second document, so that the third document can be generated. For example, even when the number of characters included in the second document is larger than the number of characters included in the first document, a component that can be combined with the component described in the first document can be extracted from the second document, so that the third document can be generated.

As described above, with use of the information processing system of one embodiment of the present invention, a user can prepare a document related to an intellectual property with less workload. In addition, the method can assist the user in new creation. As described above, one embodiment of the present invention can provide an information processing device, an information processing method, and an information processing system that are highly convenient and useful.

### Structure Example 1 of Information Processing System

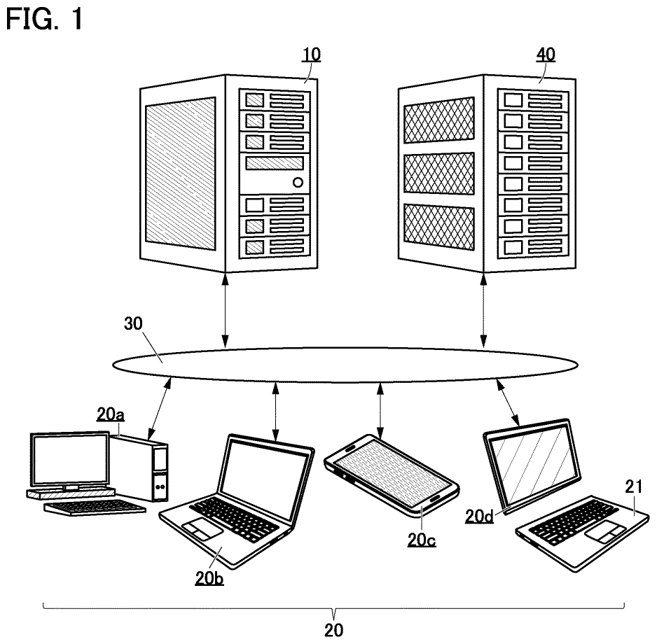

FIG. 1 is a schematic view showing a structure example of the information processing system of one embodiment of the present invention. The information processing system of one embodiment of the present invention includes an information processing device 10 and an information processing device 40. The information processing device 10 and the information processing device 40 are connected to each other via a network 30 and can transmit and receive data.

The information processing device 40 has a function of performing processing using a language model. The language model has a function of generating a response sentence on the basis of a prompt. The prompt is regarded as an input sentence for causing the language model to perform an intended operation. The prompt is transmitted from the information processing device 10 to the information processing device 40, for example. The response sentence generated by the language model is transmitted from the information processing device 40 to the information processing device 10, for example. Note that the information processing device 10 may have a function of performing processing using a language model.

The information processing system of one embodiment of the present invention may be configured such that the user can directly operate the information processing device 10 to input a document or the like, or may be configured such that the user can input a document or the like with an information terminal 20 connected to the information processing device 10 via the network 30, as illustrated in FIG. 1.

Structure examples of the information processing device 10, the information processing device 40, the information terminal 20, and the network 30 are described below.

### Structure Example of Information Processing Device 10

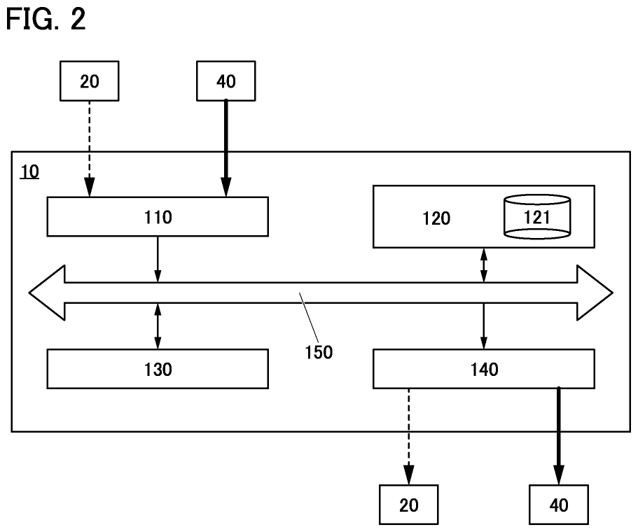

FIG. 2 is a block diagram showing a structure example of the information processing device 10. The information processing device 10 includes a reception unit 110, a memory unit 120, a processing unit 130, an output unit 140, and a transmission path 150. FIG. 2 also illustrates the information terminal 20 and the information processing device 40.

### Reception Unit 110

The reception unit 110 has a function of receiving data from the outside of the information processing device 10. The reception unit 110 has a function of receiving data representing a document, for example, from the information terminal 20. The reception unit 110 has a function of receiving data representing a response sentence, for example, from the information processing device 40.

The reception unit 110 has a function of transmitting the received data to one or both of the memory unit 120 and the processing unit 130 via the transmission path 150. As the reception unit 110, a device such as a wired communication port, a wireless communication port, or an optical communication port can be used, for example.

### Memory Unit 120

The memory unit 120 has a function of storing a program to be executed by the processing unit 130. The memory unit 120 may have a function of storing data (e.g., an arithmetic result, an analysis result, and an inference result) created by the processing unit 130, data received by the reception unit 110, and the like.

The memory unit 120 includes a database 121. A reference is stored in the database 121. Examples of references include known references; specific examples thereof include a published patent application, a patent publication, a utility model registration publication, a design publication, a paper, a book, and a journal. Note that an unknown reference may be stored in the database 121. The reference stored in the memory unit 120 is one mode of a technical document.

The database 121 is not necessarily provided in the memory unit 120. The database 121 may be provided outside the information processing device 10, for example.

### Processing Unit 130

The processing unit 130 has a function of performing processing such as arithmetic processing, analysis, and inference with use of data transmitted from one or both of the reception unit 110 and the memory unit 120. The processing unit 130 can transmit created data (e.g., an arithmetic result, an analysis result, or an inference result) to one or both of the memory unit 120 and the output unit 140. The processing unit 130 has a function of creating a prompt. Note that the processing unit 130 may have a function of performing processing using a language model.

The processing unit 130 has a function of obtaining data from the memory unit 120. The processing unit 130 may have a function of storing or registering data in the memory unit 120.

### Output Unit 140

The output unit 140 has a function of outputting at least one of an arithmetic result, an analysis result, and an inference result in the processing unit 130 to the outside of the information processing device 10. As the output unit 140, a device such as a wired communication port, a wireless communication port, or an optical communication port can be used, for example.

For example, the output unit 140 has a function of transmitting data representing a prompt or the like to the information processing device 40. The output unit 140 also has a function of transmitting data representing a document or the like and information included in the response sentence to the information terminal 20.

### Transmission Path 150

The transmission path 150 has a function of transmitting data. Data transmission and reception among the reception unit 110, the memory unit 120, the processing unit 130, and the output unit 140 can be performed through the transmission path 150. As the transmission path 150, a bus line on a motherboard, a wired communication cable, or an optical communication cable can be used, for example.

### Structure Example of Information Processing Device 40

The information processing device 40 can process the received data and transmit the processing result. For example, the information processing device 40 can perform arithmetic processing or the like using data transmitted from the information processing device 10. The information processing device 40 can transmit the processing result to the information processing device 10. Accordingly, arithmetic processing loads on the information processing device 10 can be reduced.

The information processing device 40 can perform processing using a language model, as described above. For example, the information processing device 40 can perform processing using a language model such as BERT or T5. Furthermore, the information processing device 40 can perform processing using a language-model-based model (a text generation model, an interactive model, or the like).

The language model generates a response sentence on the basis of a prompt, as described above. For example, a prompt created by the processing unit 130 is transmitted to the language model of the information processing device 40 through the output unit 140. The response sentence generated by the language model is transmitted to one or both of the memory unit 120 and the output unit 140, for example, through the reception unit 110.

Furthermore, the information processing device 40 can perform processing using a general-purpose language processing model capable of performing a variety of natural language processing tasks.

The information processing device 40 is a large computer such as a server computer or a supercomputer. The information processing device 40 preferably has a function of a parallel computer. When the information processing device 40 is used as a parallel computer, large-scale computation necessary for artificial intelligence (AI) learning and inference can be performed, for example.

Note that the information processing device 40 is a computer having higher processing capability than the information processing device 10. For example, in the case where both the information processing device 10 and the information processing device 40 have a function of a parallel computer, the information processing device 40 having higher processing capability than the information processing device 10 enables larger-scale computation. For another example, in the case where both the information processing device 10 and the information processing device 40 can perform processing using a language-model-based model, the information processing device 40 can perform processing using a larger-scale model as compared with the information processing device 10.

Note that a service provider does not necessarily have its own information processing device 40. For example, a service provider can utilize part of the service that another company or the like provides using the information processing device 40.

### Structure Example of Information Terminal 20

The information terminal 20 can receive data input by the user of the information processing system of one embodiment of the present invention. The information terminal 20 can present data output from the information processing system of one embodiment of the present invention to the user by displaying the data on a display portion of the information terminal 20. Alternatively, the information terminal 20 can present data output from the information processing system of one embodiment of the present invention to the user by printing the data by a printing unit included in the information terminal 20.

The information terminal 20 can transmit data received from the user to the information processing device 10. The information terminal 20 can present data transmitted from the information processing device 10 to the user.

The information terminal 20 can transmit data created on the basis of the data received from the user to the information processing device 10. The information terminal 20 can present data created on the basis of the data transmitted from the information processing device 10 to the user.

Dedicated application software and a web browser, for example, are installed on the information terminal 20. The user can access the information processing device 10 through the dedicated application software, the web browser, or the like. Thus, the user can enjoy a service based on the information processing system of one embodiment of the present invention by using a computer whose processing capability is lower than that of the information processing device 10, for example, as the information terminal 20.

The information terminal 20 can also be referred to as a client computer or the like. Any type of the information terminal 20 is an information terminal used by the user of the information processing system of one embodiment of the present invention.

For example, a desktop computer 20a, a laptop computer 20b, a smartphone 20c, or a tablet computer 20d can be used as the information terminal 20. Note that the tablet computer 20d can also be used as a laptop computer when connected to a housing 21 including a keyboard.

### Network 30

The network 30 connects the information processing device 10 and the information processing device 40. The network 30 also connects a plurality of the information terminals 20 and the information processing device 10. Thus, input data and processed data can be transmitted and received between the information processing devices 10 and 40 and between the information terminals 20 and the information processing device 10. Furthermore, information processing loads can be dispersed.

An information processing method using the information processing system shown in FIG. 1 and FIG. 2 is described below. Specifically, a method for operating the information processing device 10 is described.

### Information Processing Method 1

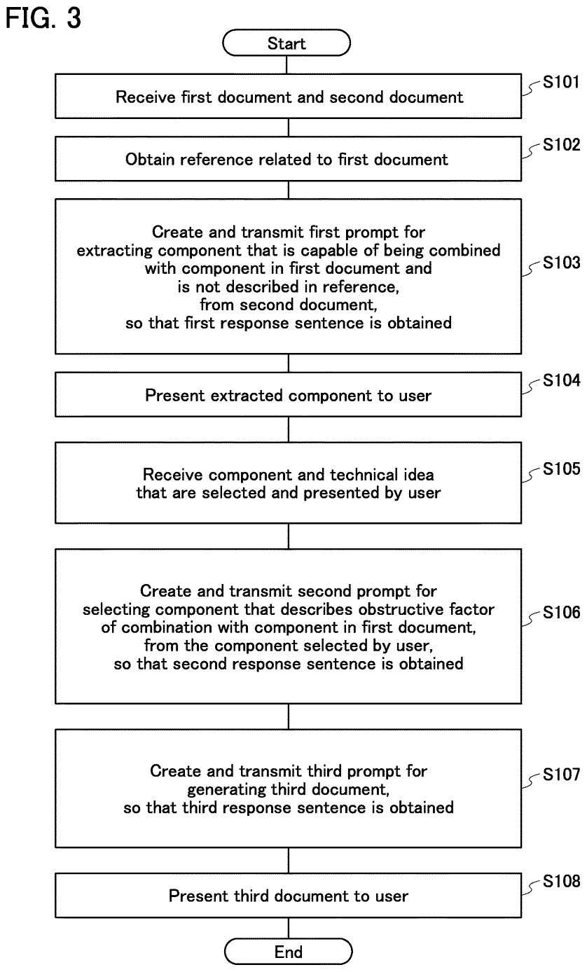

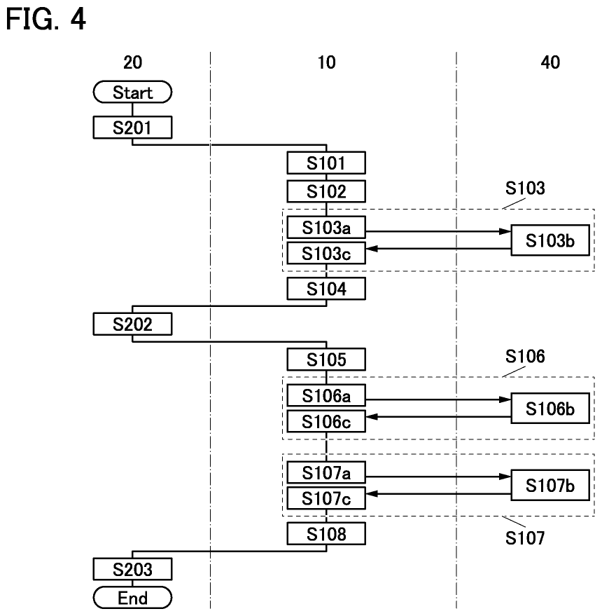

FIG. 3 and FIG. 4 are flow charts showing an example of an information processing method of one embodiment of the present invention. FIG. 3 shows a process example executed by the information processing device 10. FIG. 4 shows which of the information terminal 20, the information processing device 10, and the information processing device 40 is used for each process.

In the information processing method of one embodiment of the present invention, the third document is generated on the basis of the first and second documents with use of a language model, as described above. The first to third documents can be technical documents as described above.

As described above, the first document can be a document describing creation to be filed, specifically, an invention, a device, or the like. Specifically, the first document describes a component of the creation. Hereinafter, the component described in the first document is referred to as a first component in some cases.

The first document can be a creation notification, for example. Here, the creation notification means a document describing the creation related to an application for a person who files the application. The creation notification is prepared by a creator (an inventor, or the like), for example. Examples of a person who files an application include a patent attorney and a patent engineer belonging to a patent firm. Another example of the person who files an application is a person who belongs to an intellectual property division in the same company as that of the creator. Note that a person him-or herself who has prepared the first document may file an application using the information processing method of one embodiment of the present invention.

In the case of filing a patent application, the first document can be an invention notification. In that case, the first document is prepared by an inventor, for example. In the case of filing a utility model registration application, the first document can be a device notification. In that case, the first document is prepared by an inventor, for example.

The second document is a document related to the first document as described above. The second document includes a material, data, and the like related to the creation described in the first document. The second document can be, for example, a report of an experiment related to the creation described in the first document. Here, the second document may include a material, data, and the like that are not directly related to the creation described in the first document. The second document can include, for example, a material, data, and the like related to an experiment, which are in the same field as that of the first document but not directly related to the first component described in the first document. Note that the second document may be a paper, a book, a journal, or the like, which is related to the creation described in the first document; for example, the second document may be a patent application document, an utility model registration application document, a design registration application document, a paper, a book, a journal, or the like, which has not been disclosed.

The third document can be an application document related to intellectual property rights as described above, e.g., a specification belonging to a patent application or a specification belonging to a utility model registration application.

When the information processing method of one embodiment of the present invention “starts”, Step S201 shown in FIG. 4 is performed before Step S101 shown in FIG. 3 is performed. In Step S201, a user of the information terminal 20 inputs the first document and the second document to the information processing device 10. In other words, in Step S201, the information terminal 20 receives the first document and the second document and outputs them to the information processing device 10. Here, the user of the information terminal 20 may input one second document to the information processing device 10 or may input a plurality of second documents to the information processing device 10.

Step S101 shown in FIG. 3 is performed after Step S201 shown in FIG. 4. In Step S101, the reception unit 110 receives the first document and the second document.

Next, in Step S102 shown in FIG. 3, the processing unit 130 obtains a reference related to the first document. The processing unit 130 obtains one or more references. The processing unit 130 obtains one or more references related to the first document from references stored in the database 121 shown in FIG. 2, for example. The reference can be a reference searched out from the database 121 on the basis of the first document, for example. The reference is one mode of the technical document as described above.

In this specification, “search” refers to finding a reference highly relevant to a search query document from a plurality of search target references. In the above example, the search query document is the first document. For example, a reference in the same field as the creation described in the first document can be searched out. For example, in the case where the creation described in the first document is creation related to a battery, the processing unit 130 obtains a reference related to batteries. Moreover, searching for a document in a further classified field may be performed. For example, in the case where the creation described in the first document is creation related to an electrolyte solution included in a battery, the processing unit 130 can obtain a reference related to electrolyte solutions.

Next, Step S103 shown in FIG. 3 is performed. Step S103 includes Step S103a, Step S103b, and Step S103c as shown in FIG. 4.

In Step S103a, the processing unit 130 creates a first prompt and transmits it to the information processing device 40 through the output unit 140. Specifically, the first prompt is transmitted to a language model of the information processing device 40. The first prompt is a prompt for extracting a component that can be combined with the first component described in the first document and is not described in the obtained reference from the second document. Here, the component that can be combined with the first component and is not described in the obtained reference is referred to as a second component in some cases. The first prompt can be a prompt for extracting a plurality of second components.

The first prompt includes the first document, the second document, and the obtained reference. The first prompt includes instruction sentences such as “The first component described in the first document is the center of creation. Extract a component that can be combined with the first component and is not described in the following reference from the second document as the second component. Show the second component in bullet points.”

In Step S103b, the information processing device 40 creates a first response sentence on the basis of the first prompt by using the language model and transmits the first response sentence to the reception unit 110. Thus, in Step S103c, the information processing device 10 obtains the first response sentence. The first response sentence includes the second component.

With use of the language model in extracting the second component, the extraction of the second component from the second document is possible even when the volume of the second document is extremely large. For example, even when the number of characters included in the second document is larger than the number of characters included in the first document, the second component can be extracted from the second document.

Next, in Step S104 in FIG. 3, the processing unit 130 presents the second component to the user of the information processing system. For example, the second component is transmitted to the information terminal 20 through the output unit 140. Thus, the second component is displayed on the display portion of the information terminal 20. After Step S104, an input from the user of the information processing system is received in Step S202 shown in FIG. 4. Examples of the input include selection results and technical ideas that will be described later.

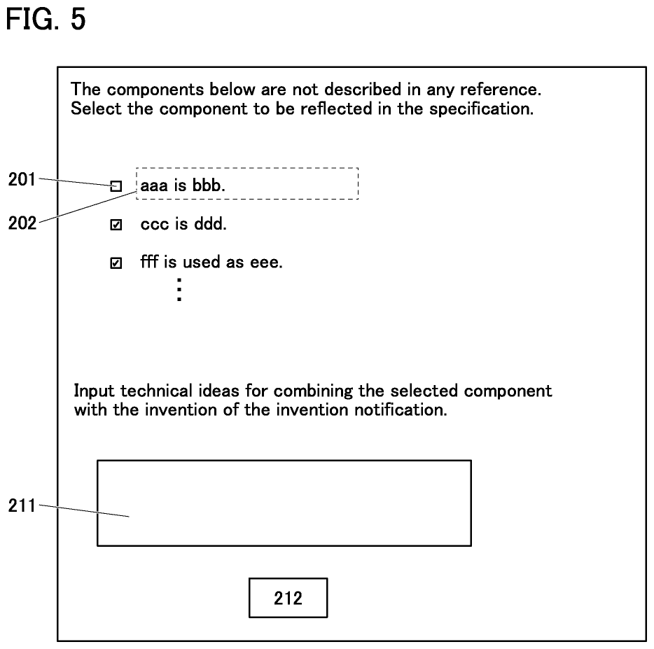

FIG. 5 shows an example of information displayed on the display portion of the information terminal 20 in Step S104. In other words, FIG. 5 shows as an example of a graphical user interface (GUI) of the information processing system of one embodiment of the present invention. A form, an icon, a table, and the like in the GUI-related drawings such as FIG. 5 exemplified in this embodiment are examples, and there is no particular limitation. A GUI can be constructed as a web page accessed by the user of the information processing system via the network 30. Alternatively, a GUI can be constructed as a screen of a program application executed on the information terminal 20.

In the example shown in FIG. 5, a component 202 is described under a sentence “The components below are not described in any reference. Select the component to be reflected in the specification.” The component 202 corresponds to the above-described second component. In the example shown in FIG. 5, three components 202 are described. The descriptions of the components 202 in the example shown in FIG. 5 are “aaa is bbb.”, “ccc is ddd.”, and “fff is used as eee.” Here, the specification corresponds to the above-described third document. The third document is generated by the language model in a step described later.

In the example shown in FIG. 5, a check box 201 is provided for each component 202. The component to be reflected in the third document can be selected by placing a check mark in the check box 201. In the example shown in FIG. 5, check marks are placed in the check boxes 201 corresponding to “ccc is dd” and “fff is used as eee.” Note that the user of the information processing system may select all the components 202.

For example, the user of the information processing system clicks the check box 201, thereby inputting a check mark. Furthermore, the user of the information processing system clicks the check box 201 to which the check mark has been input, thereby deleting the check mark. Note that the check box 201 may be selected with a keyboard, for example. In the case where the information terminal 20 includes a touch panel, the user of the information processing system may touch the check box 201, thereby selecting the check box 201. The following selection operations can also be performed in a similar manner. Note that instead of the check box 201, a radio button or a text box may be displayed, for example.

In the example shown in FIG. 5, a sentence “Input technical ideas for combining the selected component with the invention of the invention notification.” is shown below the check box 201 and the component 202. A form 211 and a button 212 are shown below the sentence. Here, the invention notification corresponds to the above-described first document. Note that in the case where the first document is device notification, the “invention” can be replaced with the “device.”

The user of the information processing system inputs a technical idea for combining the selected component 202 with the first component described in the first document, to the form 211. Examples of the technical idea include an effect of combining the selected component 202 with the first component. Specific relevance between the first component and the selected component 202 can be given as the example. Furthermore, ingenuity conducted for combining the first component and the selected component 202 can also be given as the example. Note that in the case where the user of the information processing system selects a plurality of components 202, the technical ideas for the respective plurality of components 202 can be input to the form 211. In this case, one form 211 may be provided, or separate forms 211 may be provided for the respective selected components 202.

When the user of the information processing system selects the button 212, the information terminal 20 transmits the component 202 whose check box 201 has a check mark, to the information processing device 10, as a selection result. The information terminal 20 transmits the technical idea that has been input into the form 211 to the information processing device 10. Here, the component 202 transmitted to the information processing device 10 as a selection result is referred to as a third component in some cases.

In Step S202, the user of the information terminal 20 inputs the third component and the technical idea to the information processing device 10. In other words, in Step S202, the information terminal 20 receives the third component and the technical idea and outputs them to the information processing device 10.

Step S105 shown in FIG. 3 is performed after Step S202 shown in FIG. 4. In Step S105, the reception unit 110 receives the above-described third component and technical idea. Specifically, the reception unit 110 receives the third component selected from the second component and the technical idea related to the third component.

In Step S104 described above, the component 202 that cannot be combined with the first component described in the first document is sometimes presented to the user of the information processing system. In addition, the component 202 having little sense in combination with the first component is sometimes presented to the user of the information processing system. Thus, performing Step S202 and Step S105 can prevent the third document generated in a later step from including these components. As a result, the highly complete third document can be prepared.

Next, Step S106 shown in FIG. 3 is performed. Step S106 includes Step S106a, Step S106b, and Step S106c as shown in FIG. 4.

In Step S106a, the processing unit 130 creates a second prompt and transmits the second prompt to the information processing device 40 through the output unit 140. Specifically, the second prompt is transmitted to the language model of the information processing device 40. The second prompt is a prompt for selecting a component describing an obstructive factor of combination with the first component, from the third component, that is, the component 202 selected by the user. The obstructive factor is described in the reference obtained by the processing unit 130 in Step S102. The second prompt is a prompt for presenting the obstructive factor. Here, a component selected on the basis of the second prompt is referred to as a fourth component in some cases. The second prompt can be a prompt for obtaining one or more fourth components.

The second prompt includes a first document, a reference, and a third component. The second prompt includes an instruction sentence such as “Select a component which has a factor described in the references here and obstructing combination with the first component described in the first document, from the third components shown here. Present the obstructive factor.”

In Step S106b, the information processing device 40 creates a second response sentence on the basis of the second prompt by using the language model and transmits the second response sentence to the reception unit 110. Thus, in Step S106c, the information processing device 10 obtains the second response sentence. The second response sentence includes the above-described fourth component. The second response sentence includes the obstructive factor. Moreover, the second response sentence may include all the third components. In other words, the language model may select all the third components included in the second prompt. In that case, all the third components are the fourth component.

For example, even when a reference describing the component 202 itself shown in FIG. 5 is not included in the references obtained by the processing unit 130 in Step S102, there is a possibility that a reference describing a component that is a superordinate concept of the component 202 exists. In addition, there is a possibility that any of the references obtained by the processing unit 130 describes an obstructive factor of combining the component that is a superordinate concept with the first component described in the first document. In that case, the fourth component included in the second response sentence can be a component that is a subordinate concept of the component describing an obstructive factor.

The fourth component and an obstructive factor for combining the fourth component with the first component may be presented to the user of the information processing system. In that case, a reference describing the obstructive factor is also preferably presented to the user. When the fourth component and the obstructive factor are presented to the user, the user can select a component included in the third document that is to be generated in the later step on the basis of the obstructive factor, for example. When determining that the obstructive factor is inappropriate, for example, the user can prevent the fourth component from being included in the third document.

When the reference describing an obstructive factor is presented to the user, an instruction sentence representing the fact is included in the second prompt. For example, the second prompt includes a sentence “In addition, show the reference describing an obstructive factor.” When the fourth component and the obstructive factor are presented to the user, an instruction sentence for showing the fourth component and the obstructive factor in bullet points is preferably included in the second prompt. For example, the second prompt preferably includes a sentence “Show the selected component and the obstructive factor in combining the selected component with the first component in bullet points.”

Next, Step S107 shown in FIG. 3 is performed. Step S107 includes Step S107a, Step S107b, and Step S107c as shown in FIG. 4.

In Step S107a, the processing unit 130 creates a third prompt and transmits the third prompt to the information processing device 40 through the output unit 140. Specifically, the third prompt is transmitted to the language model of the information processing device 40. The third prompt is a prompt for generating the third document. The third document is generated on the basis of the component that is a combination of the first component and the fourth component, a technical idea related to the fourth component in the technical ideas input by the user of the information processing system in Step S202, and the above obstructive factor for combining the first component with the fourth component. Here, the component that is a combination of the first component and the fourth component is referred to as a fifth component in some cases.

When a plurality of fourth components exist, some of the fourth components, e.g., one of them is combined with the first component may be used as the fifth component, or all of the fourth components may be combined with the first component to be the fifth component. In the case where the fifth component is composed of some of the fourth components combined with the first component, the third document can be a document describing a plurality of fifth components. For example, in the case where the first component is “A” and the fourth component is composed of two components “B” and “C”, examples of the fifth component include “A+B”, “A+C”, and “A+B+C”. The third document may describe only the combination of “A+B+C” or describe the combinations of “A+B” and “A+C”. In the case where the combinations of “A+B” and “A+C” are described, the combination of “A+B+C” may be described or is not necessarily described. In the example shown in FIG. 5, “ccc is ddd.” corresponds to the component “B”, and “fff is used as eee.” corresponds to the component “C”. Note that “ccc” and “eee” are included in the first component, i.e., the component “A”. Similarly, “aaa” is also included in the first component, i.e., the component “A”.

The third prompt includes the first document, the second document, the fourth component, a technical idea, and the obstructive factor. The technical idea can be, for example, a technical idea related to the fourth component. The third prompt includes instruction sentences such as “Generate a document of a component that is a combination of the first component described in the first document and the fourth component. In the document to be generated, describe that the component that is a combination of the first component and the fourth component is effective in the technical idea included here, on the basis of the second document, although an obstructive factor is considered as existing in the conventional technical ideas.”

In Step S107b, the information processing device 40 creates a third response sentence on the basis of the third prompt by using the language model and transmits the third response sentence to the reception unit 110. Thus, in Step S107c, the information processing device 10 obtains the third response sentence. The third response sentence includes the third document.

Next, in Step S108 in FIG. 3, the processing unit 130 presents the third document to the user of the information processing system. For example, the third document is transmitted to the information terminal 20 through the output unit 140. Thus, the third document is displayed on the display portion of the information terminal 20. After Step S108, the user confirms the third document in Step S203 shown in FIG. 4. In Step S203, the user modifies the third document, for example. Note that modification of the third document may be performed using the language model. The third document can be stored in the memory unit 120. For example, the modified third document can be stored in the memory unit 120.

Accordingly, the information processing method of one embodiment of the present invention “ends”.

As described above, with use of the information processing system of one embodiment of the present invention, creation such that all the components are not described in one reference and an obstructive factor in combining the components is described in any of references can be presented, and a third document can be prepared on the basis of the creation. Accordingly, with the information processing system of one embodiment of the present invention, a component that satisfactorily meets the novelty and the inventive step can be presented, and the third document can be prepared on the basis of the presented component. Thus, the information processing system of one embodiment of the present invention can assist the user in new creation. In addition, a highly complete document related to an intellectual property can be prepared.

Furthermore, with the information processing system of one embodiment of the present invention, the language model is used for extracting a component from the second document and preparation of the third document, so that the user can prepare a document related to an intellectual property with less workload. In addition, a document related to an intellectual property can be formed in a short time. Note that Step S106 is not necessarily performed in the information processing method of one embodiment of the present invention. Even in such a case, the above advantageous effect can also be obtained.

As described above, one embodiment of the present invention can provide an information processing device, an information processing method, and an information processing system that are highly convenient and useful.

### Information Processing Method 2

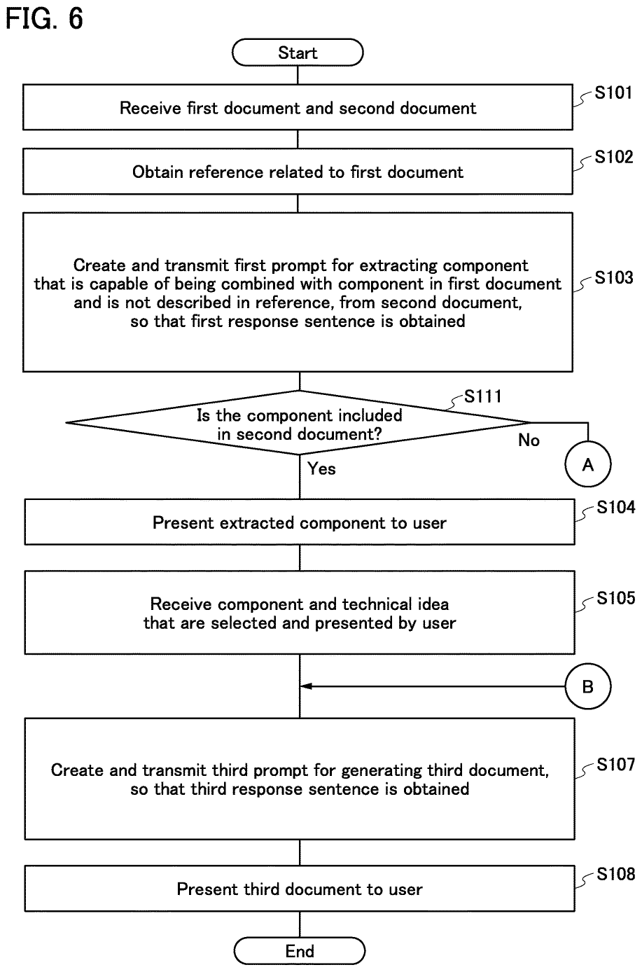

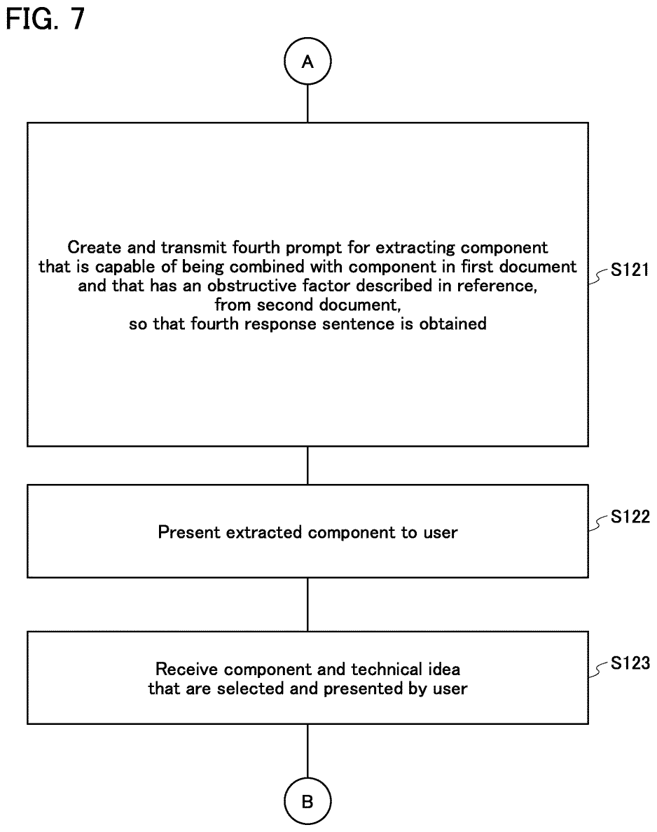

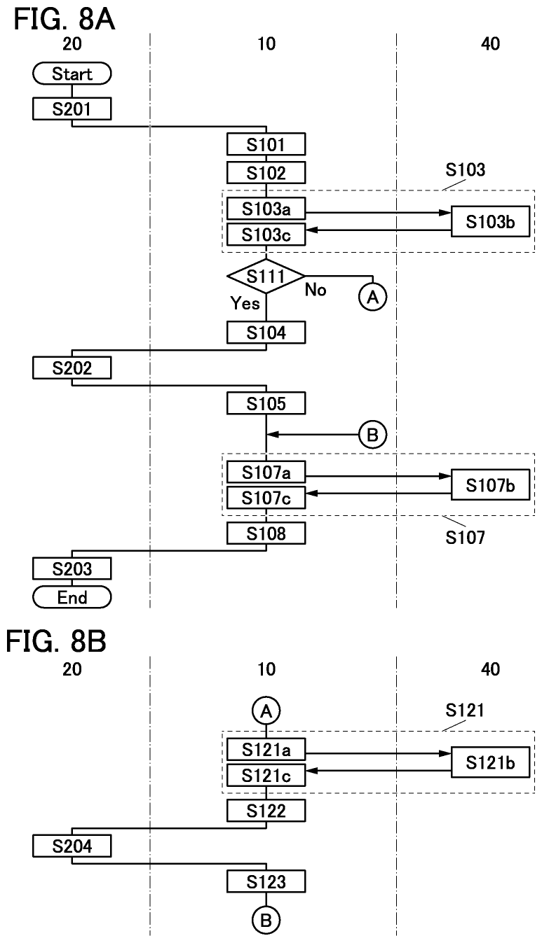

FIG. 6 and FIG. 7 are flow charts showing an example of the information processing method of one embodiment of the present invention, which is different from that in FIG. 3. FIGS. 8A and 8B are flow charts showing an example different from that in FIG. 4. FIGS. 8A and 8B show which of the information terminal 20, the information processing device 10, and the information processing device 40 is used for each process. In FIG. 6, FIG. 7 and FIGS. 8A and 8B, the same steps as the steps included in the information processing method shown in FIG. 3 and FIG. 4 are denoted by the same reference numerals. Also in the subsequent flowcharts, the same steps are denoted by the same reference numerals.

When the information processing method shown in FIG. 6 and FIG. 8A “starts”, Step S201 and Step S101 to Step S103 are performed. After Step S103 is performed, the processing unit 130 determines, in Step S111, whether or not the first response sentence includes the second component that can be combined with the first component described in the first document and is not described in the reference obtained in Step S102. Here, in the case where the second component is not included in the second document, i.e., the case where all the components included in the second document are described in any of the references, it is preferable to include an instruction sentence describing the fact in the first prompt in Step S103. For example, the first prompt preferably includes an instruction sentence such as “In the case where the second component cannot be extracted, show the fact”.

In the case where the second component is included in the first response sentence, Step S104, Step S202, Step S105, Step S107, Step S108, and Step S203 are performed. Here, Step S106 is not performed. In this case, the third prompt in Step S107 includes the first document, and the third component and a technical idea input by the user of the information processing system in Step S202. The third prompt includes an instruction sentence such as “Generate a document for a component that is a combination of the first component in the first document and the third component, and include a technical idea in the document to be generated.” In the above case, in the third document generated in Step S107, a component that is a combination of the first component and the third component is presented as the fifth component.

In the case where the second component is not included in the first response sentence, i.e., the case where the second component cannot be extracted from the second document, the process proceeds to Connector A from the branching point of Step S111. Connector A is connected to Step S121 shown in FIG. 7 and FIG. 8B. Step S121 includes Step S121a, Step S121b, and Step S121c.

In Step S121a, the processing unit 130 creates a fourth prompt and transmits it to the information processing device 40 through the output unit 140. Specifically, the fourth prompt is transmitted to the language model of the information processing device 40. The fourth prompt can be combined with the first component described in the first document and is a prompt for extracting a component describing an obstructive factor of combination with the first component, from the second document. The obstructive factor is described in the reference obtained by the processing unit 130 in Step S102. Here, a component extracted from the second document on the basis of the fourth prompt is referred to as a sixth component in some cases. The fourth prompt can be a prompt for obtaining one or more sixth components. By the fourth prompt, a component that includes an obstructive factor of combination with the first component, although the component itself is described in the reference, can be extracted as the sixth component from the second document.

The fourth prompt includes the first document, the second document, and the reference obtained by the processing unit 130 in Step S102. The fourth prompt includes an instruction sentence such as “Extract a component that has a factor described in the references here and obstructing combination with the first component described in the first document, from the second document here. Present the obstructive factor.”

In Step S121b, the information processing device 40 creates a fourth response sentence on the basis of the fourth prompt by using the language model and transmits the fourth response sentence to the reception unit 110. Thus, in Step S121c, the information processing device 10 obtains the fourth response sentence. The fourth response sentence includes the sixth component. The fourth response sentence includes the obstructive factor.

Next, in Step S122 in FIG. 7, the processing unit 130 presents the sixth component to the user of the information processing system. For example, the sixth component is transmitted to the information terminal 20 through the output unit 140. Thus, the sixth component is displayed on the display portion of the information terminal 20. After Step S122, an input from the user of the information processing system is received in Step S204 shown in FIG. 8B. Examples of the input include a selection result and a technical idea that will be described later.

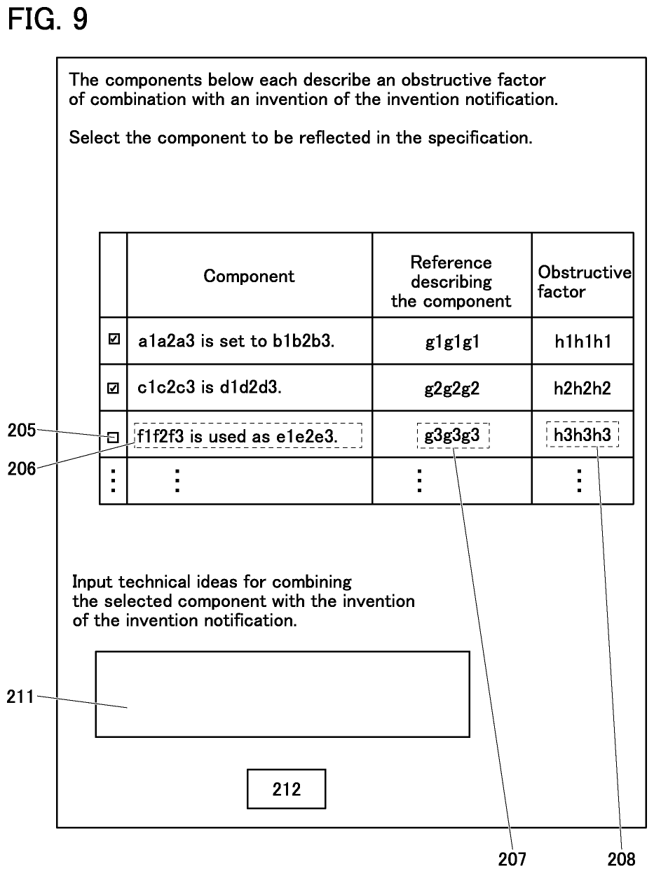

FIG. 9 shows an example of information that is displayed on the display portion of the information terminal 20 in Step S122. In other words, FIG. 9 shows an example of a GUI related to the information processing system of one embodiment of the present invention.

In the example shown in FIG. 9, a table is shown below a sentence “The components below each describe an obstructive factor of combination with an invention of the invention notification. Select the component to be reflected in the specification.” Note that the “invention notification” shown in FIG. 9 corresponds to the above-described first document. When the first document is a device notification in the example shown in FIG. 9, the “invention” can be replaced with the “device”. The specification corresponds to the third document. The third document is generated by the language model in a subsequent step, Step S108.

The table shown in FIG. 9 includes a “component” column, a “reference describing the component” column, and an “obstructive factor” column. The “component” column is for listing components 206. The component 206 corresponds to the sixth component.

References 207 each describing the component 206 are listed in the “reference describing the component” column. For example, information specifying the reference 207 is shown. As the information, an identification number assigned to the reference 207 can be given. Besides, one or more of the title of the reference 207, the date such as the publication date thereof, the author thereof, a publisher thereof, a text included therein, and the like can be given as the information. For example, in the case where the reference 207 is a published patent application, examples of the information for specifying the reference 207 can include an application management number for identifying an application (including an internal unique number), an application family management number for identifying an application family, an application number, a publication number, an inventor, an applicant, a drawing, an abstract, an application date, a priority date, a publication date, a status, a patent classification, a category, and a keyword. Note that not only a number but also a character may be included in an identification number such as an application management number, an application number, or a publication number. At least one of them can be displayed as information specifying the reference 207 in the “reference describing the component” column.

Here, it is preferable that when the user of the information processing system selects information specifying the reference 207, the content of the selected reference 207 be displayed. For example, in the case where the reference 207 is a publication of patent application, it is preferable that when information specifying the reference 207 is selected, the specification, the drawing, the scope of claims, the summary, and the like be displayed.

In the “obstructive factor” column, obstructive factors 208 of combining the component 206 with the first component described in the first document are listed. Here, it is preferable that when the user of the information processing system selects the obstructive factor 208, a reference describing the selected obstructive factor 208 be displayed. In particular, it is preferable to make a portion describing the obstructive factor 208 explicit. For example, the background color, the font color, the font size, or the font type in the portion describing the obstructive factor 208 may be made different from those in the other portion, or the text in the portion may be made bold or underlined, as a way for making the portion explicit.

In the example shown in FIG. 9, three components 206 are presented. In the example shown in FIG. 9, the presented components 206 are “a1a2a3 is set to b1b2b3.”, “c1c2c3 is d1d2d3.”, and “f1f2f3 is used as e1e2e3.” The reference 207 describing the component “a1a2a3 is set to b1b2b3.” is “g1g1g1”, and the obstructive factor 208 related to the component is “h1h1h1”. The reference 207 describing the component “c1c2c3 is d1d2d3.” is “g2g2g2”, and the obstructive factor 208 related to the component is “h2h2h2”. The reference 207 describing the component “f1f2f3 is used as e1e2e3.” is “g3g3g3”, and the obstructive factor 208 related to the component is “h3h3h3”.

In the example shown in FIG. 9, a check box 205 is provided for each component 206. The component to be reflected in the third document can be selected by placing a check mark in the check box 205. In the example shown in FIG. 9, check marks are placed in the check boxes 205 corresponding to “a1a2a3 is set to b1b2b3.” and “c1c2c3 is d1d2d3.” Note that instead of the check box 205, a radio button or a text box may be displayed, for example.

In the example shown in FIG. 9, a sentence “Input technical ideas for combining the selected component with the invention of an invention notification.” is shown below the table. The form 211 and the button 212 are shown below the sentence.

The user of the information processing system inputs a technical idea for combining the selected component 206 with the first component described in the first document, to the form 211. For the technical idea, the description for FIG. 5 can be referred to by replacing the component 206 with the component 202.

When the user of the information processing system selects the button 212, the information terminal 20 transmits the component 206 whose check box 205 has a check mark to the information processing device 10 as a selection result. The information terminal 20 transmits the technical idea that has been input into the form 211 to the information processing device 10. Here, the component 206 transmitted to the information processing device 10 as a selection result is referred to as a seventh component in some cases.

In Step S204, the user of the information terminal 20 inputs the seventh component and the technical idea to the information processing device 10. In other words, in Step S204, the information terminal 20 receives the seventh component and the technical idea and outputs them to the information processing device 10.

After Step S204 shown in FIG. 8B, Step S123 shown in FIG. 7 is performed. In Step S123, the reception unit 110 receives the seventh component and the technical idea. Specifically, the reception unit 110 receives the seventh component selected from the sixth component and the technical idea related from the seventh component.

In Step S122 described above, the component 206 that cannot be combined with the first component described in the first document is sometimes presented to the user of the information processing system. In addition, the component 206 having little sense in combination with the first component is sometimes presented to the user of the information processing system. Thus, performing Step S204 and Step S123 can prevent the third document generated in a later step from including these components. As a result, the highly complete third document can be prepared.

Next, the process proceeds to Connector B. Connector B is connected to Step S107 shown in FIG. 6 and FIG. 8A. In the information processing method shown in FIG. 6. FIG. 7, and FIGS. 8A and 8B, the third document is generated on the basis of a component that is a combination of the first and seventh components, the technical idea input by the user of the information processing system in Step S204, and the obstructive factor of combining the first and seventh components. Here, the component of a combination of the first and seventh components is referred to as an eighth component in some cases. For Step S107, Step S108, and Step S203, the description of FIG. 3 and FIG. 4 can be referred to by replacing the fourth component and the fifth component, respectively, with the seventh component and the eighth component.

Accordingly, the information processing method shown in FIG. 6 to FIG. 9 “ends”.

Even when all the components described in the first document and the second document are described in any of the references, for example, the information processing method shown in FIG. 6 to FIG. 9 enables extraction, from the second document, a component that has a factor described in any of the references and obstructing combination with the component described in the first document. Then, creation that is a combination of the extracted component with the component described in the first document is presented, and the third document based on the creation can be prepared. Accordingly, with the information processing system of one embodiment of the present invention, a component that satisfactorily meets the novelty and the inventive step can be presented, and the third document can be prepared on the basis of the presented component. Thus, the information processing system of one embodiment of the present invention can assist the user in new creation. In addition, a highly complete document related to an intellectual property can be prepared.

### Information Processing Method 3

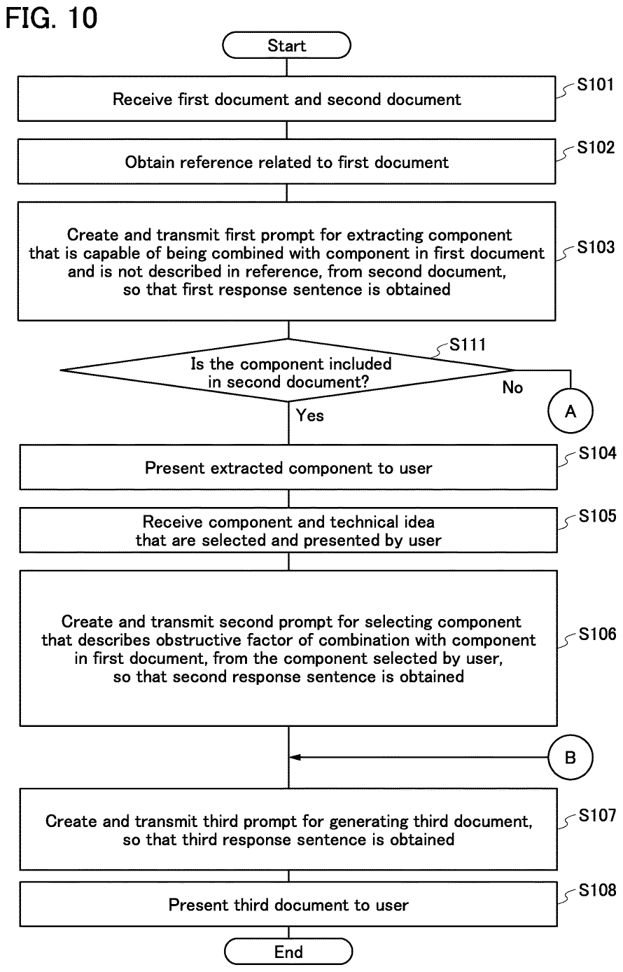

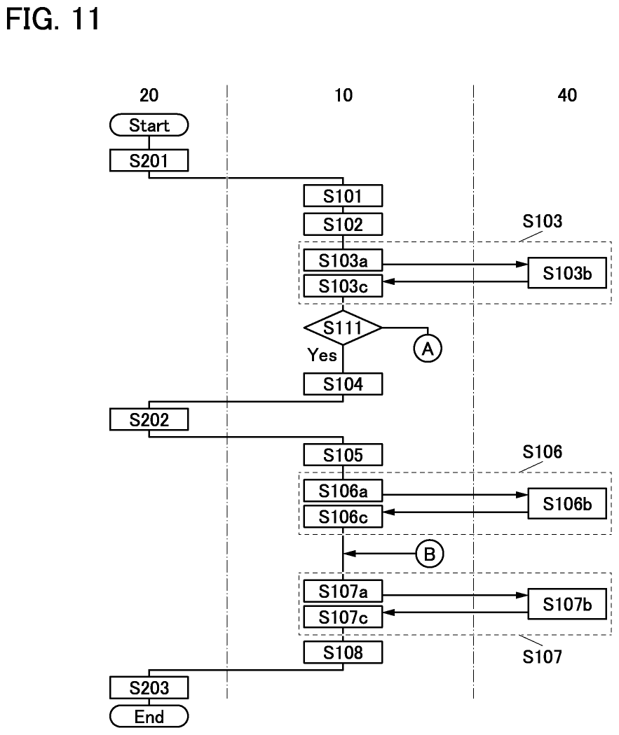

FIG. 10 is a flow chart showing an example of the information processing method of one embodiment of the present invention, which is different from that in FIG. 3 and FIG. 6. FIG. 11 is a flow chart showing an example different from those in FIG. 4 and FIG. 8A. FIG. 11 shows which of the information terminal 20, the information processing device 10, and the information processing device 40 is used for each process.

When the information processing method shown in FIG. 10 and FIG. 11 “starts”, Step S201, Step S101 to Step S103, and Step S111 are performed as in the information processing method illustrated in FIG. 6 and FIG. 8A. In the case where it is determined that the second component is included in the first response sentence in Step S111, Step S104, Step S202, Step S105 to Step S108, and Step S203 are performed. Here, unlike the example shown in FIG. 6 and FIG. 8A, Step S106 shown in FIG. 3 and FIG. 4 is also performed. In the case where it is determined that the second component is included in the first response sentence, the process proceeds to Connector A from the branching point of Step S111. The processing from Connector A to Connector B is similar to the processing shown in FIG. 7 and FIG. 8B. After the process proceeds to Connector B, Step S107, Step S108, and Step S203 are performed as in the information processing method shown in FIG. 6 and FIG. 8A.

Accordingly, the information processing method shown in FIG. 10 and FIG. 11 “ends”. The information processing method shown in FIG. 10 and FIG. 11 can be regarded as an information processing method obtained by combining the method shown in FIG. 3 and FIG. 4 and the method shown in FIG. 6, FIG. 7, and FIGS. 8A and 8B. The information processing method shown in FIG. 10 and FIG. 11 enables presentation of a component such that creation is more easily presented than that with the method shown in FIG. 3 and FIG. 4 and such that the novelty and the inventive step are more likely to be met satisfactorily than those with the method shown in FIG. 6 and FIG. 8A.

### Information Processing Method 4

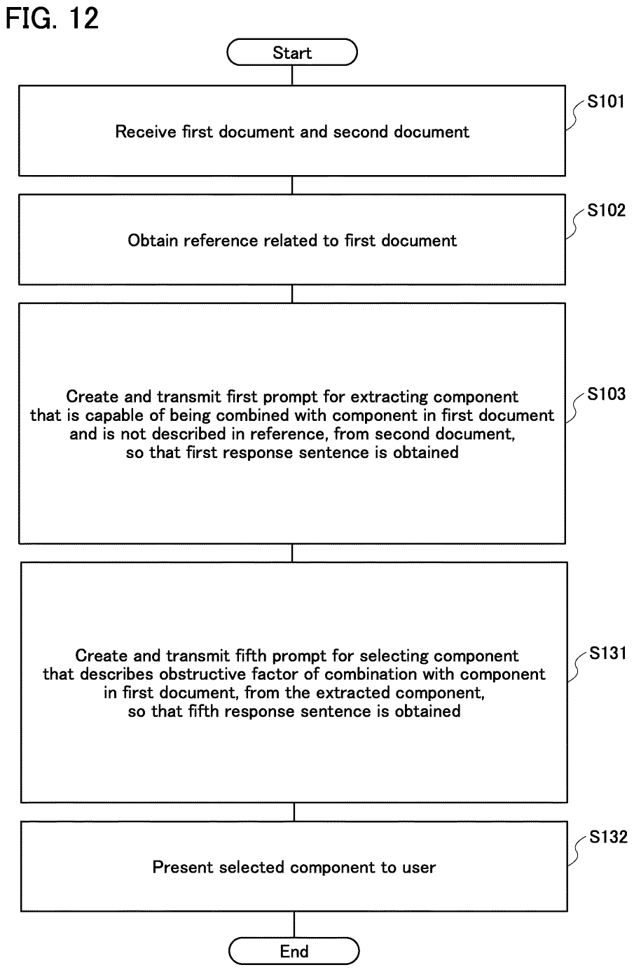

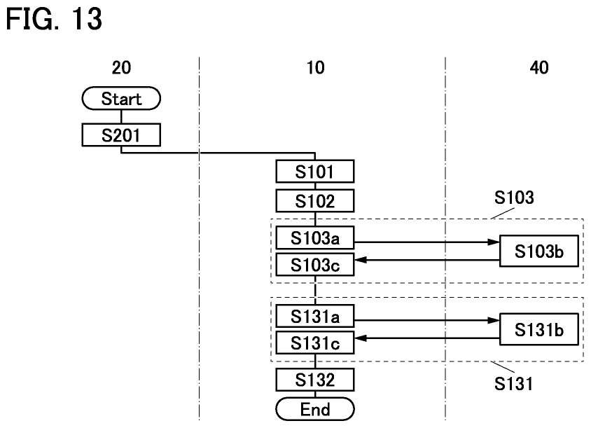

FIG. 12 is a flow chart showing an example of the information processing method of one embodiment of the present invention, which is different from those in FIG. 3, FIG. 6, FIG. 7, and FIG. 10. FIG. 13 is a flow chart showing an example different from those in FIG. 4, FIGS. 8A and 8B, and FIG. 11. FIG. 13 shows which of the information terminal 20, the information processing device 10, and the information processing device 40 is used for each process.

When the information processing method shown in FIG. 12 and FIG. 13 “starts”, Step S201, Step S101 to Step S103 are performed. After Step S103 is performed, Step S131 is performed. Step S131 includes Step S131a, Step S131b, and Step S131c.

In Step S131a, the processing unit 130 creates a fifth prompt and transmits it to the information processing device 40 through the output unit 140. Specifically, the fifth prompt is transmitted to the language model of the information processing device 40. The fifth prompt is a prompt for selecting a component describing an obstructive factor of combination with the first component, form the components extracted from the second document in Step S103. The obstructive factor is described in the reference obtained by the processing unit 130 in Step S102. Here, a component selected on the basis of the fifth prompt is referred to as a ninth component in some cases.

The fifth prompt includes the first document, the second component obtained by the processing unit 130 in Step S103, and the reference obtained by the processing unit 130 in Step S102. The fifth prompt includes instruction sentences such as “Select a component that has a factor described in the references here and obstructing combination with the first component, from the second component shown here. Present the obstructive factor.”

In Step S131b, the information processing device 40 creates a fifth response sentence on the basis of the fifth prompt by using the language model and transmits the fifth response sentence to the reception unit 110. Thus, in Step S131c, the information processing device 10 obtains the fifth response sentence. The fifth response sentence includes the ninth component. The fifth response sentence includes the above obstructive factor.

Next, in Step S132 in FIG. 12, the processing unit 130 presents the ninth component to the user of the information processing system. For example, the ninth component is transmitted to the information terminal 20 through the output unit 140. Thus, the ninth component is displayed on the display portion of the information terminal 20.

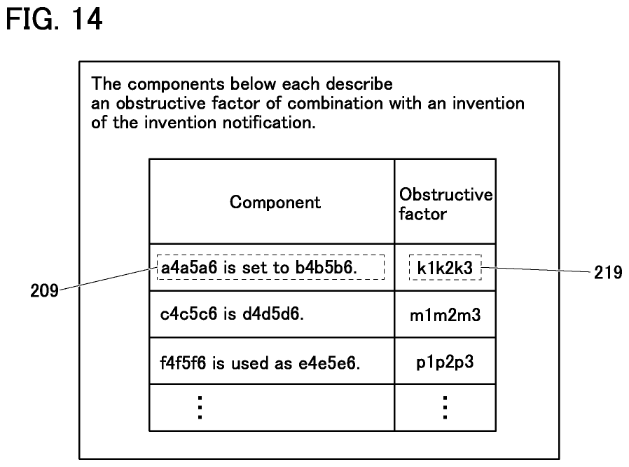

FIG. 14 shows an example of information displayed on the display portion of the information terminal 20 in Step S132. In other words, FIG. 14 shows an example of a GUI related to the information processing system of one embodiment of the present invention.

In the example shown in FIG. 14, a table is shown below a sentence “The components below each describe an obstructive factor of combination with an invention of the invention notification.” Note that “invention notification” shown in FIG. 14 corresponds to the above-described first document. When the first document is a device notification in the example shown in FIG. 14, the “invention” can be replaced with the “device”.

The table shown in FIG. 14 includes a “component” column and an “obstructive factor” column. The “component” column is for listing components 209. The component 209 corresponds to the ninth component.

In the “obstructive factor” column, obstructive factors 219 of combining the component 209 with the first component described in the first document are listed. Here, it is preferable that when the user of the information processing system selects the obstructive factor 219, a reference describing the selected obstructive factor 219 be displayed. In particular, it is preferable to make a portion describing the obstructive factor 219 explicit. As a way for making the portion explicit, a method similar to the above-described method for making the portion describing the obstructive factor 208 explicit can be used.

In the example shown in FIG. 14, three components 209 are presented. In the example shown in FIG. 14, the presented components 209 are “a4a5a6 is set to b4b5b6.”, “c4c5c6 is d4d5d6.”, and “f4f5f6 is used as e4e5e6.” The obstructive factor 219 related to the component “a4a5a6 is set to b4b5b6.” is “k1k2k3”. The obstructive factor 219 related to the component “c4c5c6 is d4d5d6.” is “m1m2m3”. The obstructive factor 219 related to the component “f4f5f6 is used as e4e5e6.” is “p1p2p3”.

Accordingly, the information processing method shown in FIG. 12, FIG. 13, and FIG. 14 “ends”.

With the information processing method shown in FIG. 12, FIG. 13, and FIG. 14, a component that is described in the second document and has a factor described in the reference and obstructing combination with the first component can be presented to the user of the information processing system. Here, the second document can be an experimental report as described above, for example. Thus, the user can, for example, perform detailed examination of the presented component. For example, additional experiment can be conducted. Then, for example, a specification can be prepared in consideration of the examination results. In the above manner, a highly complete document related to an intellectual property can be prepared.

### Structure Example 2 of Information Processing System

A detailed structure example of the information processing system of one embodiment of the present invention is described below. Specifically, the structure examples to be described are for the memory unit 120, the processing unit 130, and the network 30 that are illustrated in FIG. 1 and FIG. 2, which have not been shown in <Structure example 1 of information processing system>.

The memory unit 120 includes at least one of a volatile memory and a nonvolatile memory. Examples of the volatile memory include a dynamic random-access memory (DRAM) and a static random-access memory (SRAM). Examples of the nonvolatile memory include a resistive random-access memory (ReRAM, also referred to as a resistance-change memory), a phase-change random-access memory (PRAM), a ferroelectric random-access memory (FeRAM), a magnetoresistive random-access memory (MRAM, also referred to as a magnetoresistive memory), and a flash memory. The memory unit 120 may include at least one of a NOSRAM (registered trademark) and a DOSRAM (registered trademark). The memory unit 120 may include a recording media drive. Examples of the recording media drive include a hard disk drive (HDD) and a solid-state drive (SSD).

Note that “NOSRAM” is an abbreviation for a nonvolatile oxide semiconductor random-access memory. The NOSRAM refers to a memory in which a two-transistor (2T) or three-transistor (3T) gain cell is used as a memory cell and the transistor includes a metal oxide in its channel formation region (such a transistor is also referred to as an OS transistor). The OS transistor has an extremely low current that flows between a source and a drain in an off state, that is, an extremely low leakage current. The NOSRAM retains electric charge corresponding to data in memory cells by using characteristics of extremely low leakage current, thereby capable of being used as a nonvolatile memory. In particular, the NOSRAM is capable of reading retained data without destruction (non-destructive reading), and thus is suitable for arithmetic processing in which only a data reading operation is repeated many times. The NOSRAM can have large data capacity when stacked in layers; hence, a semiconductor device in which the NOSRAM is used for a large-scale cache memory, a large-scale main memory, a large-scale storage memory, or the like can have higher performance.

The DOSRAM is an abbreviation for dynamic oxide semiconductor RAM, which indicates a RAM including one transistor (1T) and one capacitor (1C). The DOSRAM is a DRAM formed using an OS transistor, and a memory that temporarily stores data sent from the outside. The DOSRAM is a memory utilizing a low off-state current of an OS transistor.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably contains indium (In), and for example, indium oxide is preferably used. When the metal oxide included in the channel formation region is a metal oxide containing indium, the carrier mobility (electron mobility) of the OS transistor is high. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high binding energy with oxygen. The element M is, for example, an element that has higher binding energy with oxygen than indium does. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The metal oxide included in the channel formation region may be, for example, a metal oxide that does not contain indium and contains any of zinc, gallium, and tin, e.g., zinc tin oxide and gallium tin oxide.

The processing unit 130 can include an arithmetic circuit, for example. The processing unit 130 can include, for example, a central processing unit (CPU). The processing unit 130 can include a graphics processing unit (GPU).

The processing unit 130 may include a microprocessor such as a digital signal processor (DSP). The microprocessor may be configured with a programmable logic device (PLD) such as a field programmable gate array (FPGA) or a field programmable analog array (FPAA). The processing unit 130 may include a quantum processor. The processing unit 130 can interpret and execute instructions from programs to process various kinds of data and control programs. The programs to be executed by the processor are stored in at least one of the memory unit 120 and a memory region of the processor.

The processing unit 130 may include a main memory. The main memory includes at least one of a volatile memory such as a random access memory (RAM) and a nonvolatile memory such as a read only memory (ROM). The main memory may include at least one of the above-described NOSRAM and DOSRAM.

Examples of the RAM include a DRAM and an SRAM; a virtual memory space is assigned and utilized as a working space of the processing unit 130. An operating system, an application program, a program module, program data, a look-up table, and the like which are stored in the memory unit 120 are loaded into the RAM for execution. The data, program, and program module which are loaded into the RAM are each directly accessed and operated by the processing unit 130.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultra-violet erasable programmable read only memory (UV-EPROM) which can erase stored data by irradiation with ultraviolet rays, an electrically erasable programmable read only memory (EEPROM), and a flash memory.

The processing unit 130 can include one or both of an OS transistor and a transistor including silicon in its channel formation region (a Si transistor).

The processing unit 130 preferably includes an OS transistor. The OS transistor has an extremely low off-state current; therefore, with use of the OS transistor as a switch for retaining electric charge (data) that has flowed into a capacitor functioning as a memory element, a long data retention period can be obtained. When at least one of a register and a cache memory included in the processing unit 130 has such a feature, the processing unit 130 can be operated only when needed, and otherwise can be off while data processed immediately before turning off the processing unit 130 is stored in the memory element. In other words, normally-off computing is possible and the power consumption of the information processing system can be reduced.

As the network 30, the Internet, which is a global network and works as the infrastructure of the World Wide Web (WWW), can be used, for example. Moreover, a local network can be used as the network 30. An intranet or an extranet can be used as the network 30. A network such as a personal area network (PAN), a local area network (LAN), a campus area network (CAN), a metropolitan area network (MAN), a wide area network (WAN), or a global area network (GAN) can be used as the network 30.

In the case where a service provider using the information processing method of one embodiment of the present invention and the user who enjoys the service belong to the same organization such as a company, data transmission and reception between the information terminal 20 and the information processing device 10 is preferably performed using a network constructed in the organization, for example. Thus, data can be transmitted and received between the information terminal 20 and the information processing device 10 more safely than in the case where data is transmitted via the Internet. Furthermore, leakage of confidential information in the organization to the outside can be prevented.

Note that as communication protocols or communication technology for wireless communication, it is possible to use communication standards such as the fourth-generation mobile communication system (4G), the fifth-generation mobile communication system (5G), or the sixth-generation mobile communication system (6G); or communication standards developed by the Institute of Electrical and Electronics Engineers (IEEE), such as Wi-Fi (registered trademark) or Bluetooth (registered trademark).

This application is based on Japanese Patent Application Serial No. 2025-082327 filed with Japan Patent Office on May 16, 2025, the entire contents of which are hereby incorporated by reference.

What is claimed is:

1. An information processing method comprising:
obtaining a first document describing a first component, at least one second document related to the first document, and at least one reference related to the first document;
transmitting to a language model a first prompt for extracting a plurality of components that are capable of being combined with the first component and are not described in the reference from the second document, so that a plurality of second components are obtained;
obtaining a plurality of third components selected from the plurality of second components and technical ideas related to the respective plurality of third components;
transmitting to the language model a second prompt for selecting a component that has a factor described in the reference and obstructing combination with the first component from the plurality of third components, so that at least one fourth component is obtained;
transmitting to the language model a third prompt for generating a document based on a fifth component that is a combination of the first component and the fourth component, any of the technical ideas related to the fourth component, and the obstructive factor, so that a third document is obtained; and
presenting the third document.

2. An information processing method comprising:
a first step, a second step, a third step, a fourth step, a fifth step, a sixth step, a seventh step, and an eighth step,
wherein in the first step, a first document describing a first component and at least one of second documents related to the first document are received,
wherein in the second step, at least one reference related to the first document is obtained,
wherein in the third step, a first prompt for extracting a plurality of second components that are capable of being combined with the first component and are not described in the reference from the second document is created and transmitted to a language model,
wherein in the fourth step, the plurality of second components are presented,
wherein in the fifth step, a plurality of third components selected from the plurality of second components and technical ideas related to the respective plurality of third components are received,
wherein in the sixth step, a second prompt for extracting at least one fourth component that has a factor described in the reference and obstructing combination with the first component from the plurality of third components is created and transmitted to the language model,
wherein in the seventh step, a third prompt for generating a third document based on a fifth component that is a combination of the first component and the fourth component, any of the references related to the fourth component, and the obstructive factor is created and transmitted to the language model, and
wherein in the eighth step, the third document is presented.

3. The information processing method according to claim 1, wherein a number of characters included in the second document is larger than a number of characters included in the first document.

4. The information processing method according to claim 1, wherein the reference is stored in a database.

5. The information processing method according to claim 1, wherein each of the first document, the second document, the third document, and the reference is a technical document.

6. The method for information processing method according to claim 5, wherein the third document is a specification belonging to a patent application or a specification belonging to a utility model registration application.

7. The method for information processing method according to claim 5,
wherein the first document is a document describing creation, and
wherein the second document is a report of an experiment related to the creation.

8. An information processing device comprising:
a reception unit;
an output unit; and
a processing unit,
wherein the reception unit is configured to receive a first document describing a first component, at least one second document that is related to the first document and describes a second component, a plurality of third components selected from the second component, and technical ideas related to the respective plurality of third components,
wherein the output unit is configured to transmit a first prompt, a second prompt, and a third prompt to a language model,
wherein the output unit is configured to output the second component and a third document,
wherein the processing unit is configured to obtain at least one reference related to the first document,
wherein the processing unit is configured to create the first prompt for extracting a plurality of the second components that are capable of being combined with the first component and are not described in the reference,
wherein the processing unit is configured to present the extracted second components,
wherein the processing unit is configured to create the second prompt for selecting at least one fourth component that has a factor described in the reference and obstructing combination with the first component from the plurality of third components, and
wherein the processing unit is configured to create the third prompt for generating the third document based on a fifth component that is a combination of the first component and the fourth component, any of the technical ideas related to the fourth component, and the obstructive factor.

9. The information processing device according to claim 8, wherein a number of characters included in the second document is larger than a number of characters included in the first document.

10. The information processing device according to claim 8, wherein the reference is stored in a database.

11. The information processing device according to claim 8, wherein each of the first document, the second document, the third document, and the reference is a technical document.

12. The information processing device according to claim 11, wherein the third document is a specification belonging to a patent application or a specification belonging to a utility model registration application.

13. The information processing device according to claim 11,
wherein the first document is a document describing creation, and
wherein the second document is a report of an experiment related to the creation.

14. The information processing method according to claim 2, wherein a number of characters included in the second document is larger than a number of characters included in the first document.

15. The information processing method according to claim 2, wherein the reference is stored in a database.

16. The information processing method according to claim 2, wherein each of the first document, the second document, the third document, and the reference is a technical document.

17. The method for information processing method according to claim 16, wherein the third document is a specification belonging to a patent application or a specification belonging to a utility model registration application.

18. The method for information processing method according to claim 16,
wherein the first document is a document describing creation, and
wherein the second document is a report of an experiment related to the creation.
